(19) United States
(12) Patent Application Publication
(10) Pub. No.: US 2006/0124155 A1
(43) Pub. Date: Jun. 15, 2006

(54) Technique for reducing backside particles

(76) Inventors: David Edwin Suuronen, Newburyport, MA (US); Arthur Paul Riaf, Gloucester, MA (US); Paul Stephen Buccos, Haverhill, MA (US); Kevin Michael Daniels, Wakefield, MA (US); Paul J. Murphy, Reading, MA (US); Lawrence Ficarra, Billerica, MA (US); Kenneth L. Starks, Gloucester, MA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/239,000

(22) Filed: Sep. 30, 2005

Related U.S. Application Data
(60) Provisional application No. 60/635,524, filed on Dec. 13, 2004.

(51) Int. Cl. B08B 3/02

(52) U.S. Cl. 134/33; 134/34; 134/56 R; 134/172; 134/902

(57) ABSTRACT

A technique for reducing backside particles is disclosed. In one particular exemplary embodiment, the technique may be realized as an apparatus for reducing backside particles. The apparatus may comprise a delivery mechanism configured to supply a cleaning substance to a platen, wherein the platen is housed in a process chamber. The apparatus may also comprise a control unit configured to cause the process chamber to reach a first pressure level, cause the cleaning substance to be supplied to a surface of the platen, and cause the process chamber to reach a second pressure level, thereby removing contaminant particles, together with the cleaning substance, from the surface of the platen.

### CROSS-REFERENCE TO RELATED APPLICATIONS

This patent application claims priority to U.S. Provisional Patent Application No. 60/635,524, filed Dec. 13, 2004, which is hereby incorporated by reference herein in its entirety.

### FIELD OF THE DISCLOSURE

The present disclosure relates generally to semiconductor manufacturing equipment and, more particularly, to a technique for reducing backside particles.

### BACKGROUND OF THE DISCLOSURE

Manufacturing of microelectronic products, such as microprocessors, integrated circuits (ICs) and other micro-devices, requires a clean environment with a low level of pollutants such as dust, aerosol particles and chemical vapors. Such a clean environment is typically provided by housing semiconductor manufacturing equipment inside clean-rooms and by controlling contamination inside the equipment. As feature sizes of modern microelectronics continue to shrink, what used to be a negligible number of contaminant particles can now adversely affect production yield as well as device performance.

To minimize contamination, process spaces inside semiconductor manufacturing equipment are often maintained at high or ultra-high vacuum levels. However, even at relatively high vacuum levels, unwanted particles may still be present and can contaminate semiconductor wafers processed therein. For example, in an automated system equipped with an electrostatic clamp (ESC), contaminant particles may originate from the ESC itself due to normal wear. In addition, contaminant particles may be transferred to the ESC from other sources, typically other parts of the automatic wafer handling system such as pick arm pads, orienter pads, pass-through cassettes, and buffer robot end effectors. These contaminant particles may be transferred to the semiconductor wafers, typically on the backside. Hence, these contaminant particles are often referred to as backside particles (BSP's).

It is well known to clean an ESC platen by manually wiping the platen surface with a pre-wetted semiconductor wipe such as TexWipe™ 609. However, such cleaning method often increases, rather than decreases, the BSP level. In one experiment, a 200 mm ESC was found to have a BSP level of 17,870 particles prior to cleaning. After cleaning the ESC with a TexWipe™ 609 wipe, the BSP level rose to 70,000 particles. The increase in BSP level can be attributed to the interaction between the wipe's surface texture and the microstructure of the ESC platen surface. In similar experiments, other semiconductor wipes, such as TexWipe™ Alpha 10 and MiraWipe™, were evaluated and similar results were found.

In addition, the method of manually wiping a component often requires that a vacuum chamber be opened for each cleaning and the vacuum has to be re-established afterwards. Such a process is not only time-consuming but can significantly increase cost of operation as well.

It is also well known to manually clean a process chamber with deionized (DI) water and semiconductor wipes. For example, a process chamber may be manually wiped down using a semiconductor wipe dampened with DI water. Alternatively, DI water may be manually sprayed into the process chamber, followed by a manual wiping step, in order to remove particles. However, even manual spraying of an ESC platen surface with DI water has not been attempted for fear of damaging the ESC surface coating which contacts a semiconductor wafer during electrostatic clamping.

In view of the foregoing, it would be desirable to provide a solution for removing contaminant particles which overcomes the above-described inadequacies and shortcomings.

### SUMMARY OF THE DISCLOSURE

A technique for reducing backside particles is disclosed. In one particular exemplary embodiment, the technique may be realized as an apparatus for reducing backside particles. The apparatus may comprise a delivery mechanism configured to supply a cleaning substance to a platen, wherein the platen is housed in a process chamber. The apparatus may also comprise a control unit configured to cause the process chamber to reach a first pressure level, cause the cleaning substance to be supplied to a surface of the platen, and cause the process chamber to reach a second pressure level, thereby removing contaminant particles, together with the cleaning substance, from the surface of the platen.

In accordance with other aspects of this particular exemplary embodiment, the establishment of the second pressure level in the process chamber may cause at least a portion of the cleaning substance to sublimate, thereby removing the contaminant particles from the surface of the platen.

In accordance with further aspects of this particular exemplary embodiment, the platen may be an electrostatic clamp having a composite surface coating.

In accordance with additional aspects of this particular exemplary embodiment, the apparatus may comprise a wafer handling mechanism that transfers a clean wafer onto and then from the platen, thereby removing contaminant particles from the surface of the platen.

In accordance with another aspect of this particular exemplary embodiment, the delivery mechanism may comprise a nozzle and a drive assembly. The drive assembly may be configured to position the nozzle proximate to the surface of the platen. And the control unit may be configured to cause the nozzle to spray the surface of the platen with the cleaning substance. In addition, the nozzle may be an articulated nozzle. The nozzle may be positioned approximately six inches above the surface of the platen. Further, the control unit may be capable of causing the drive assembly to sweep the nozzle across the surface of the platen, thereby applying a substantially uniform coating of the cleaning substance to the surface. Alternatively, the control unit may be capable of causing the drive assembly to move the platen in a sweeping motion relative to the nozzle, thereby applying a substantially uniform coating of the cleaning substance to the surface.

In accordance with yet another aspect of this particular exemplary embodiment, the delivery mechanism may comprise a flat member that is positioned above the surface of the platen at such a small distance that the space between the flat member and the surface of the platen causes the cleaning substance to be spread across the surface.

In accordance with still another aspect of this particular exemplary embodiment, the cleaning substance comprises one or more substances selected from a list consisting of: DI water, alcohol, carbon dioxide, ionized dry air, and ionized dry nitrogen.

In another particular exemplary embodiment, the technique may be realized as a method for reducing backside particles. The method may comprise the step of positioning a platen inside a process chamber. The method may also comprise the step of venting the process chamber to a first pressure level. The method may further comprise the step of supplying a cleaning substance to a surface of the platen. The method may additionally comprise the step of pumping the process chamber to a second pressure level, thereby removing contaminant particles, together with the cleaning substance, from the surface of the platen.

In accordance with other aspects of this particular exemplary embodiment, the pumping of the process chamber may cause at least a portion of the cleaning substance to sublimate, thereby removing the contaminant particles from the surface of the platen.

In accordance with further aspects of this particular exemplary embodiment, the platen may be an electrostatic clamp having a composite surface coating.

In accordance with additional aspects of this particular exemplary embodiment, the method may further comprise the step of spraying the cleaning substance onto the surface of the platen in a sweeping pattern, thereby applying a substantially uniform coating of the cleaning substance on the surface.

In accordance with another aspect of this particular exemplary embodiment, the cleaning substance may comprise deionized water, and a mist of the deionized water may be sprayed onto the surface of the platen to coat the surface with droplets of the deionized water.

In accordance with yet another aspect of this particular exemplary embodiment, the cleaning substance may comprise carbon dioxide, and the surface of the platen may be sprayed with a snow of the carbon dioxide, the snow comprising solid carbon dioxide particles.

In accordance with still another aspect of this particular exemplary embodiment, the cleaning substance may comprise an ionized gas, and the surface of the platen may be sprayed with the ionized gas.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 shows a block diagram illustrating an exemplary system for reducing backside particles in accordance with an embodiment of the present disclosure.

FIG. 2 shows a block diagram illustrating another exemplary system for reducing backside particles in accordance with an embodiment of the present disclosure.

FIG. 3 shows a flow chart illustrating an exemplary method for reducing backside particles from an electrostatic clamp in accordance with an embodiment of the present disclosure.

FIG. 4 shows a block diagram illustrating an exemplary system for reducing backside particles in accordance with an embodiment of the present disclosure.

FIG. 5 shows a block diagram illustrating another exemplary system for reducing backside particles in accordance with an embodiment of the present disclosure.

### DETAILED DESCRIPTION OF EXEMPLARY EMBODIMENTS

To solve the aforementioned problems associated with existing cleaning methods for semiconductor manufacturing equipment, embodiments of the present disclosure introduce an in situ cleaning technique that effectively reduces backside particles transferred to semiconductor wafers. One or more cleaning substances may be supplied to a surface of a platen (or other components) located inside a process chamber. When the process chamber is pumped down, the cleaning substance(s) may be removed from the platen (or component) surface, together with contaminant particles thereon. The following description will focus on the cleaning of a platen. However, it should be appreciated that the exemplary embodiments described herein may be easily adapted to clean other components in semiconductor manufacturing equipment.

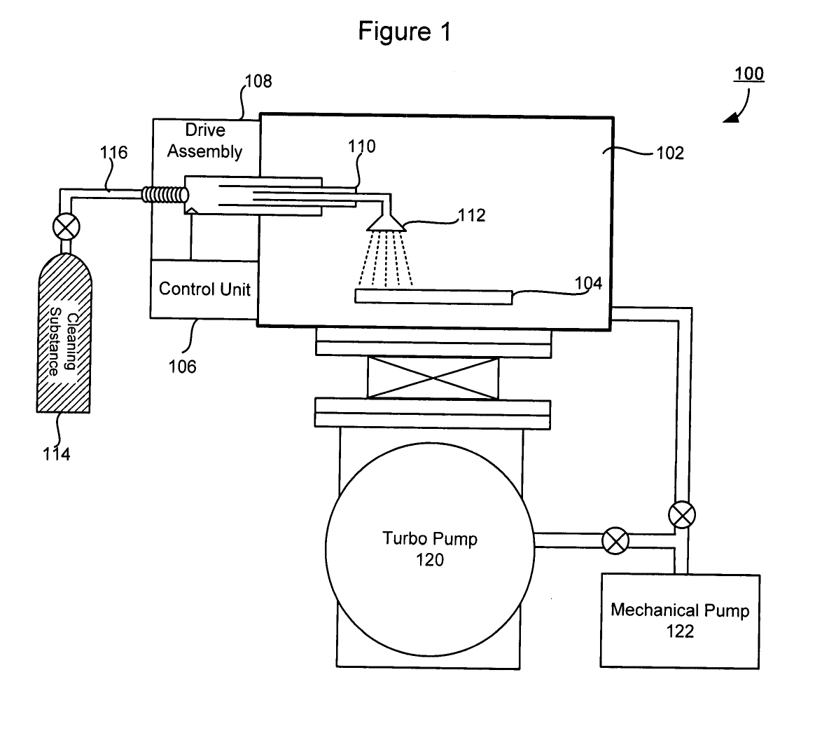

Referring to FIG. 1, there is shown a block diagram illustrating an exemplary system 100 for reducing backside particles in accordance with an embodiment of the present disclosure. The system 100 may comprise a process chamber 102 that is coupled to, for example, a turbo pump 120 and a mechanical pump 122. The vacuum pumps (120 and 122), individually or in combination, may cause the process chamber 102 to reach a desired vacuum level. The process chamber 102 may be part of semiconductor manufacturing equipment, and may serve one or more semiconductor processing functions such as, for example, chemical vapor deposition (CVD), physical vapor deposition (PVD), ion implantation, or plasma etching.

A platen 104 capable of holding one or more wafers may be housed inside the process chamber 102. The platen 104 may be part of an automatic wafer handling assembly that is capable of transferring wafers to or from an adjacent chamber (not shown). For automatic wafer handling purposes, the platen 104 may comprise an electrostatic clamp which typically may have a composite surface coating, although it should be understood that a non-electrostatic clamp with or without a composite surface coating may be used as well.

The system 100 may also comprise a control unit 106 which may facilitate control over a number of other components of the system 100. The system 100 may further comprise a drive assembly 108 which is controlled by the control unit 106 and coupled to a spray arm 110. At the end of the spray arm 110, there may be a nozzle 112. A source 114 of a cleaning substance may be coupled to the spray arm 110 via a pipeline 116, and the cleaning substance may be delivered through the spray arm 110 to the nozzle 112, which may be articulated.

The cleaning substance source 114 may contain one or more cleaning substances typically in either liquid or gaseous states. A preferred cleaning substance should be a gas or fluid that is readily available and easy to store or handle in a clean-room. A preferred cleaning substance can also be delivered in small amounts and its residual vapor can be easily removed from a vacuum chamber. Typical cleaning substances may include but are not limited to: DI water, alcohol, carbon dioxide (e.g., CO₂ snow with solid CO₂ particles), ionized dry air, or ionized dry nitrogen, etc. The ionized dry air or nitrogen may be particularly effective in removing those particles that are held to the platen surface by electrostatic forces. These ionized gases may be produced, for example, from an AirForce™ Ionizing Blow-Off Gun available from Ion Systems, Inc. According to some embodiments, it may be beneficial to use a combination of two or more cleaning substances to achieve a desired result. For example, a mixture of DI water and alcohol may be delivered through the spray arm 110 to the nozzle 112. Such a combination of two or more cleaning substances may also be referred to as one cleaning substance (i.e., in singular form).

The spray arm 110 may be a telescopic type as shown in FIG. 1, or it may be any other type of assembly that can be driven by the drive assembly 108 and controlled by the control unit 106. Through movements of the spray arm 110, the nozzle 112, which may be articulated, may be positioned in a desired location relative to a surface of the platen 104. Typically, the nozzle 112 is positioned proximate to and above the platen 104. According to one embodiment, the nozzle 112 may be approximately six inches above the platen 104.

The nozzle 112 may be capable of spraying out a controlled stream or mist of gases, liquids, or solid particles. That is, flow rates of the cleaning substance through the nozzle 112, as well as spray density, may be controlled, for example, by the control unit 106. The spray arm 110 and the nozzle 112 may also be adjusted to provide desired angles of incidence on the surface of the platen 104. When spraying, the nozzle 112 may remain stationary. Alternatively, the spray arm 110 may move the nozzle 112 in predetermined patterns, single- or multi-dimensionally, across the surface of the platen 104. Through controlled movement of the nozzle 112, as well as regulated flow rate and spray density, the surface of the platen 104 may be spray-coated with selected cleaning substance(s).

When it is desirable to clean the platen 104, the process chamber 102 may be vented to approximately atmospheric pressure (or a pressure level in the rough vacuum regime depending upon the cleaning substance's thermodynamic properties as well as conditions such as vacuum pumping flow rate, pump down time, and temperature, etc.) and the platen 104 may be placed in a safe position. The control unit 106 may, either automatically or while operated by a human operator, cause the nozzle 112 to be positioned above the platen 104 and to spray a selected cleaning substance onto the platen surface. Then, the process chamber 102 may be pumped down to a desired vacuum level (e.g., rough vacuum, or high vacuum at 10⁻⁷-10⁻⁶ Torr). As the cleaning substance sublimates (i.e., leaving the surface of the platen 104 in vapor), contaminant particles on the platen surface may be removed, either out of the process chamber 102 or onto the chamber floor. Next, the platen 104 (and/or the process chamber 102) may be optionally gettered with a clean wafer having a low particle count. The clean wafer may be briefly transferred to the platen 104 and then returned to a cassette, which process may be repeated to further reduce contaminant particles from the platen surface.

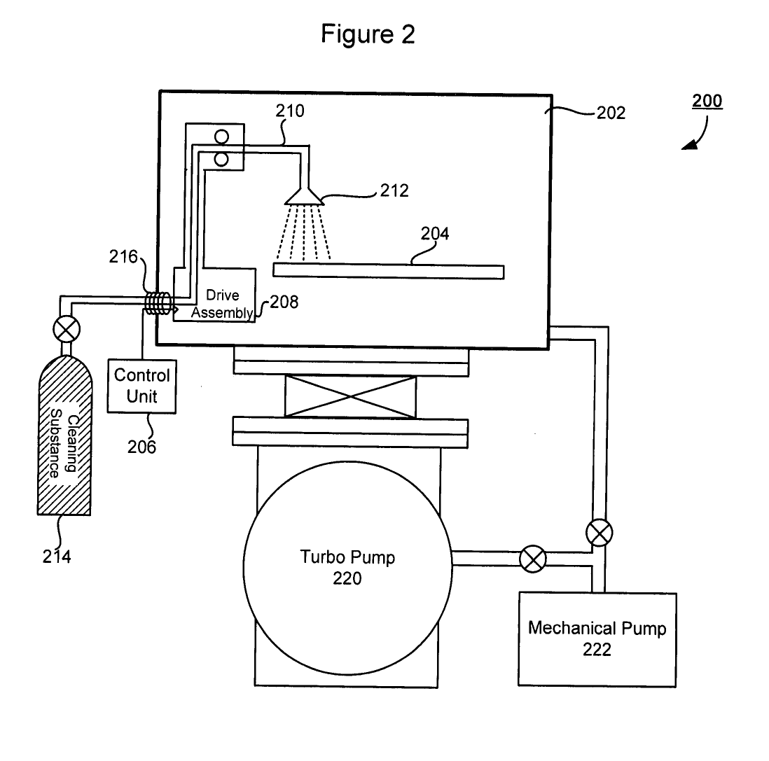

The drive assembly 108, spray arm 110, nozzle 112, cleaning substance source 114, and pipeline 116 may be collectively referred to as a “delivery mechanism”. There may be great flexibility as to where the delivery mechanism is mounted relative to the process chamber 102. As shown in FIG. 1, a good portion of the delivery mechanism (including the spray arm 110) and the control unit 106 may be externally mounted. The spray arm 110 may be configured to enter the process chamber 102 via a sealed pass-through or cut-out that is sufficient for the movement of the spray arm 110. Alternatively, at least a portion of the delivery mechanism may be mounted inside the process chamber, one example of which is shown in FIG. 2.

FIG. 2 shows a block diagram illustrating an exemplary system 200 for reducing backside particles in accordance with an embodiment of the present disclosure.

Compared with the system 100, the system 200 similarly comprises a process chamber 202 that is coupled to a turbo pump 220 and a mechanical pump 222. A platen 204 may be housed inside the process chamber 202. The system 200 may also comprise a control unit 206 and a drive assembly 208 coupled to a nozzle 212, which may be articulated, via a spray arm 210. In contrast to the system 100 as shown in FIG. 1, the drive assembly 208 of the system 200 is mounted inside the process chamber 202, in a corner of the process chamber 202 or another unobtrusive location. A source 214 of a cleaning substance may be coupled to the spray arm 210 via a feed-through or cut-out 216 in a wall of the process chamber 202. Since the control unit 206 is externally mounted, the feed-through or cut-out 216 may also accommodate electrical control lines from the control unit 206 to the drive assembly 208.

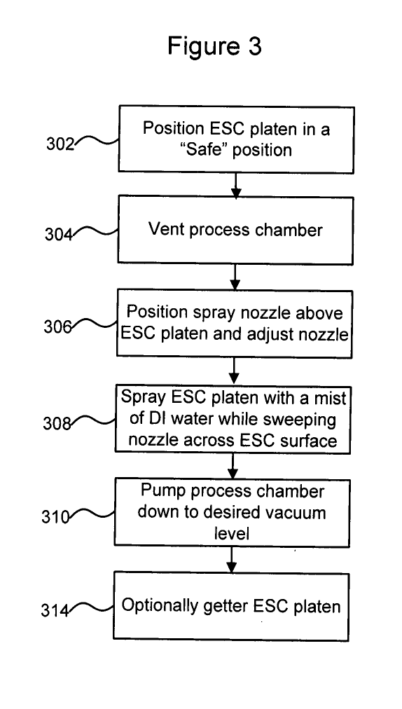

FIG. 3 shows a flow chart illustrating an exemplary method for reducing backside particles from an electrostatic clamp in accordance with an embodiment of the present disclosure. The ESC platen may be inside a process chamber or a similar vacuum chamber. The exemplary method steps may be performed before a semiconductor processing job starts in the process chamber, after a job finishes, in between different jobs, or at any other time as desired. Also, these method steps may be repeated to reach a desired cleaning result.

In step 302, the ESC platen, without any wafer thereon, may, for example, be secured in a “safe” position. It should be understood to those skilled in the art that the platen may be secured in other positions as well.

In step 304, the process chamber may be vented to approximately atmospheric pressure.

In step 306, a spray nozzle may be positioned above the ESC platen. The spray nozzle may be adjusted to provide a fine mist. Adjustment of the spray nozzle flow rate and spray density may typically depend on properties of a cleaning substance to be sprayed, as well as the expected interaction between the ESC platen surface and the cleaning substance.

In step 308, the nozzle may spray a mist of DI water onto the ESC platen surface. While spraying, the nozzle may be moved in a sweeping motion across the ESC platen surface in order for the DI water droplets to cover the surface uniformly. Alternatively, the spray nozzle, which may or may not be articulated, may be in a fixed position, and the platen may move in a sweeping motion beneath the nozzle. Instead of DI water, a mixture of DI water and alcohol or other solvents may be sprayed. Alternatively, ionized dry air or ionized dry nitrogen may be used to spray the platen surface. In general, the nozzle may supply the cleaning substance to the ESC platen surface either at a gentle speed to coat the surface or at a relatively forceful speed to remove particles through momentum transfer. Further, the spraying of the cleaning substance does not have to fully cover the ESC platen surface. When desired or when necessary, a specified portion of the surface may be sprayed and cleaned through precision movement and/or orientation of the spray nozzle (and/or the platen).

According to one embodiment of the present disclosure, a snow of carbon dioxide (CO₂) may also be used as a cleaning substance. The CO₂ snow may comprise solid CO₂ particles that can effectively blast contaminant particles off the ESC platen surface or remove particles through other surface interactions. The CO₂ snow may be created from the conversion of liquid CO₂ to solid CO₂ and CO₂ gas. The liquid CO₂ may be delivered to the spray nozzle via a high purity pipeline. Within the spray nozzle, the CO₂ liquid may expand through an orifice and be transformed into a mixture of solid CO₂ particles and CO₂ gas. This mixture may then be directed at the ESC platen surface for cleaning purposes.

In step 310, the process chamber may be pumped down to a desired vacuum level. Pumping gases from the process chamber helps remove residue of the cleaning substance to carry away contaminant particles from the ESC platen surface.

In step 314, the ESC platen may be optionally gettered with a clean wafer to further reduce its particle count.

According to embodiments of the present disclosure, the above-described cleaning method may significantly reduce the presence of contaminant particles from an ESC platen. In one experiment, a 200 mm ESC with a composite surface coating had a particle count of approximately 24,933 prior to cleaning. After the 200 mm ESC was cleaned using a DI water mist spray as described above, the particle count was reduced to approximately 11,374, a reduction of over 50%. In another experiment, a 300 mm ESC was found to have a particle count of approximately 10,597 after being manually cleaned with a semiconductor wipe. However, after the same 300 mm ESC was cleaned with a DI water mist spray, only about 2,816 particles remained, which realized a particle reduction of ˜70% compared with the conventional cleaning process.

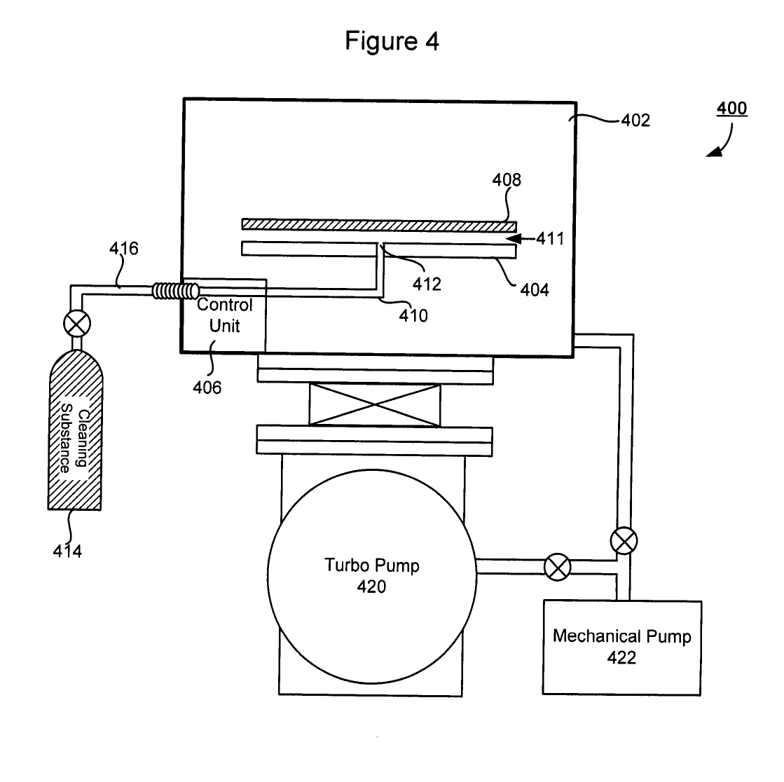

Instead of spraying a platen from above, the cleaning substance may also be supplied to the platen surface through the platen itself. FIG. 4 shows a block diagram illustrating an exemplary system 400 for reducing backside particles with this alternative approach.

The system 400 may comprise a process chamber 404 coupled to a turbo pump 420 and a mechanical pump 422. A platen 404 may be housed inside the process chamber 402. The platen 404 may have at least one feed-through channel 412 coupled with a matching pipeline 410. The feed-through channel 412 and the pipeline 410 may be part of an existing coolant delivery system (not shown) for cooling the platen 404 and any wafer thereon. In the platen 404's top surface, there may also be one or more gas channels to accommodate coolant gases.

A control unit 406 may control a supply of a cleaning substance(s) from a source 414 of a cleaning substance(s), via pipelines 416 and 410 and through the feed-through channel 412, to the surface of the platen 404.

Once supplied through the feed-through channel 412, it may be desirable to control the cleaning substance's flow and distribution across the surface of the platen 404. Accordingly, a flat member 408 may be positioned proximately above the surface of the platen 404 prior to the flowing of the cleaning substance. The flat member 408 may have a bottom surface that is substantially flat or otherwise comparable to the surface of the platen 404. According to one embodiment, the flat member 408 may be a semiconductor wafer or a similarly shaped object. The flat member 408 may be positioned at such as a small distance (e.g., 0.02-0.5 mm) from the platen 404 that a small gap 411 may be formed between the bottom surface of the flat member 408 and the surface of the platen 404. The small gap 411 may help spread the cleaning substance across the surface of the platen 404 and thus improve surface interaction. Gas channels in the platen surface will facilitate an even distribution of the cleaning substance.

At the same time as or after the cleaning substance is supplied to the platen surface, the process chamber 402 may be pumped down to a desired vacuum level to facilitate the removal of the cleaning substance together with contaminant particles from the platen 404.

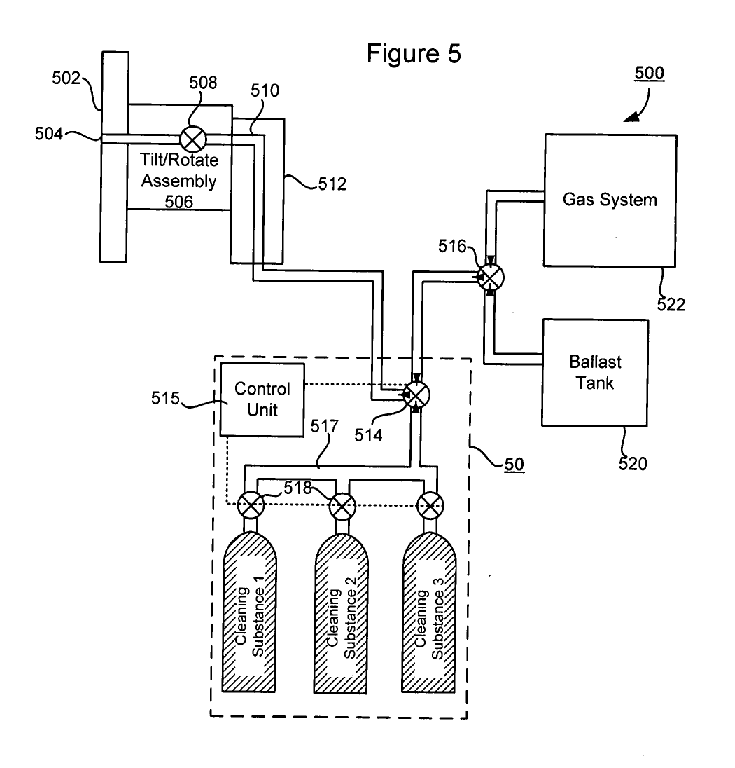

As stated above, the delivery mechanism for the cleaning substance may take advantage of an existing coolant delivery system. FIG. 5 shows a block diagram illustrating an exemplary system 500 for reducing backside particles in which an add-on subsystem 50 may be incorporated with an existing gas cooling and ballast system.

In the system 500, a platen 502 may be mounted on a tilt/rotate assembly 506. The gas cooling and ballast system may comprise a ballast tank 520, a gas system 522, a ballast valve 516, an air bearing 512, a pipeline 510, a gas cooling valve 508, and a feed-through channel 504, which, together, serve to cool the semiconductor wafer.

The add-on subsystem 50 may comprise one or more sources of a cleaning substance(s) (e.g., Cleaning Substance 1, Cleaning Substance 2, and Cleaning Substance 3). These cleaning substance sources may be coupled to a two-way valve 514 via on/off valves 518 and pipelines 517. With the two-way valve 514, the add-on subsystem 50 may take advantage of the existing setup for gas cooling. The add-on subsystem 50 may further comprise a control unit 515 that may be coupled to a control module (not shown) for the gas cooling system. The control unit 515 may regulate the valves 514 and 518 in the subsystem 50, as well as values 508 and 516, thereby controlling the flow of either cleaning substances or cooling gases to the platen 502.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. An apparatus for reducing backside particles, the apparatus comprising:
a delivery mechanism configured to supply a cleaning substance to a platen, wherein the platen is housed in a process chamber; and
a control unit configured to:
cause the process chamber to reach a first pressure level,
cause the cleaning substance to be supplied to a surface of the platen, and
cause the process chamber to reach a second pressure level, thereby removing contaminant particles, together with the cleaning substance, from the surface of the platen.

2. The apparatus according to claim 1, wherein the establishment of the second pressure level in the process chamber causes at least a portion of the cleaning substance to sublimate, thereby removing the contaminant particles from the surface of the platen.

3. The apparatus according to claim 1, wherein the platen is an electrostatic clamp having a composite surface coating.

4. The apparatus according to claim 1 further comprising:
a wafer handling mechanism that transfers a clean wafer onto and then from the platen, thereby removing contaminant particles from the surface of the platen.

5. The apparatus according to claim 1, wherein:
the delivery mechanism comprises a nozzle and a drive assembly;
the drive assembly is configured to position the nozzle proximate to the surface of the platen; and
the control unit is configured to cause the nozzle to spray the surface of the platen with the cleaning substance.

6. The apparatus according to claim 5, wherein the nozzle is an articulated nozzle.

7. The apparatus according to claim 5, wherein the nozzle is positioned approximately six inches above the surface of the platen.

8. The apparatus according to claim 5, wherein the control unit is capable of causing the drive assembly to sweep the nozzle across the surface of the platen, thereby applying a substantially uniform coating of the cleaning substance to the surface.

9. The apparatus according to claim 5, wherein the control unit is capable of causing the drive assembly to move the platen in a sweeping motion relative to the nozzle, thereby applying a substantially uniform coating of the cleaning substance to the surface.

10. The apparatus according to claim 1, wherein:
the cleaning substance comprises deionized water; and
a mist of the deionized water is sprayed onto the surface of the platen to coat the surface with droplets of the deionized water.

11. The apparatus according to claim 1, wherein:
the cleaning substance comprises carbon dioxide; and
the surface of the platen is sprayed with a snow of the carbon dioxide, the snow comprising solid carbon dioxide particles.

12. The apparatus according to claim 1, wherein:
the cleaning substance comprises an ionized gas; and
the ionized gas is supplied to the surface of the platen to neutralize electrically charged particles.

13. The apparatus according to claim 1, wherein the delivery mechanism comprises a flat member that is positioned above the surface of the platen at such a small distance that the space between the flat member and the surface of the platen causes the cleaning substance to be spread across the surface.

14. The apparatus according to claim 10, wherein the flat member is positioned approximately 0.02-0.5 mm above the surface of the platen.

15. The apparatus according to claim 10, wherein the flat member is of a shape similar to a semiconductor wafer.

16. The apparatus according to claim 10, wherein the flat member is a semiconductor wafer and the backside of the semiconductor wafer is cleaned together with the surface of the platen.

17. The apparatus according to claim 10, wherein at least a portion of the delivery mechanism is also capable of supplying the platen with a coolant.

18. The apparatus according to claim 1, wherein the cleaning substance comprises one or more substances selected from a list consisting of:
DI water,
alcohol,
carbon dioxide,
ionized dry air, and
ionized dry nitrogen.

19. The apparatus according to claim 1, wherein the second pressure level is substantially lower than the first pressure level.

20. The apparatus according to claim 1, wherein at least a portion of the apparatus is installed inside the process chamber.

21. The apparatus according to claim 1, wherein at least a portion of the apparatus is installed outside the process chamber.

22. A method for reducing backside particles, the method comprising the steps of:
positioning a platen inside a process chamber;
venting the process chamber to a first pressure level;
supplying a cleaning substance to a surface of the platen; and
pumping the process chamber to a second pressure level, thereby removing contaminant particles, together with the cleaning substance, from the surface of the platen.

23. The method according to claim 22, wherein the pumping of the process chamber causes at least a portion of the cleaning substance to sublimate, thereby removing the contaminant particles from the surface of the platen.

24. The method according to claim 22, wherein the platen is an electrostatic clamp having a composite surface coating.

25. The method according to claim 22 further comprising:
transferring a clean wafer onto and then from the platen, thereby removing contaminant particles from the surface of the platen.

26. The method according to claim 22 further comprising:
spraying the cleaning substance onto the surface of the platen in a sweeping pattern, thereby applying a substantially uniform coating of the cleaning substance on the surface.

27. The method according to claim 22, wherein:
the cleaning substance comprises deionized water; and
a mist of the deionized water is sprayed onto the surface of the platen to coat the surface with droplets of the deionized water.

28. The method according to claim 22, wherein:
the cleaning substance comprises carbon dioxide; and
the surface of the platen is sprayed with a snow of the carbon dioxide, the snow comprising solid carbon dioxide particles.

29. The method according to claim 19, wherein:
the cleaning substance comprises an ionized gas; and
the surface of the platen is sprayed with the ionized gas.

30. The method according to claim 22 further comprising:
positioning a flat member above the surface of the platen at such a small distance that the space between the flat member and the surface of the platen causes the cleaning substance to be spread across the surface.

31. The method according to claim 30, wherein the flat member is positioned approximately 0.02-0.5 mm above the surface of the platen.

32. The method according to claim 30, wherein the flat member is of a shape similar to a semiconductor wafer.

33. The method according to claim 30, wherein the flat member is a semiconductor wafer and the backside of the semiconductor wafer is cleaned together with the surface of the platen.

34. The method according to claim 22, wherein the cleaning substance comprises one or more substances selected from a list consisting of:
DI water,
alcohol,
carbon dioxide,
ionized dry air, and
ionized dry nitrogen.

35. The method according to claim 22, wherein the second pressure level is substantially lower than the first pressure level.
